(19) United States
(12) Patent Application Publication
(10) Pub. No.: US 2021/0140196 A1
(43) Pub. Date: May 13, 2021

(54) A LOCKSET INSTALLATION KIT

(71) Applicant: QUANTUM LEAP PRODUCT DESIGN PTY LIMITED, Hornsby, New South Wales (AU)

(72) Inventor: Mile VLASKI, Hornsby, New South Wales (AU)

(21) Appl. No.: 16/492,545

(22) PCT Filed: Mar. 12, 2018
(86) PCT No.: PCT/AU2018/050221

§ 371 Date: Sep. 9, 2019

Related U.S. Application Data
(60) Provisional application No. 62/470,143, filed on Mar. 10, 2017.

(51) Int. Cl. E05B 17/06; B27F 5/12

(52) U.S. Cl. CPC E05B 17/06; B23B 47/287; B27F 5/12

(57) ABSTRACT

As shown, for example in FIGS. 1 to 14, the lockset installation kit includes a door jig (1) configured for attachment to a distal end (2) of a door (3). The door jig (1) clamps to the distal end (2) and is used to guide the boring out of the door handle hole (18), the boring out of the latch bolt hole (15) and the morticing of the latch bolt plate recess (16). As shown for example in FIGS. 27 to 39, the kit also includes a frame jig (29) configured for attachment to a door frame (30). The frame jig (29) is used to guide the boring out of the strike bolt hole (65) and the morticing of the strike plate recess (46). To assist with correct alignment, the kit provides for the door jig (1) to be mechanically coupled to the frame jig (29).

### TECHNICAL FIELD

The present invention relates to devices, kits and associated methods for installing locksets into doors and door frames. Embodiments of the present invention find application, though not exclusively, in construction and renovation.

### BACKGROUND ART

Any discussion of documents, acts, materials, devices, articles or the like which has been included in this specification is solely for the purpose of providing a context for the present invention. It is not to be taken as an admission that any or all of these matters form part of the prior art base or were common general knowledge in the field relevant to the present invention as it existed in Australia or elsewhere before the priority date of this application.

A typical installation of a lockset requires installing person to use a chisel and a mallet to mortis a recess into the distal end of a door into which the latch plate is to be seated. The installer also bores out two holes in the door end to receive the latch bolt and the door handle. Similarly, the installer uses a chisel and a mallet to mortis a recess into the door frame into which the strike plate is to be seated. The installer also bores out a strike hole in the door frame.

It has been appreciated by the present inventor that it would be advantageous to provide a kit that may be of assistance during the lockset installation process.

### SUMMARY OF THE INVENTION

It is an object of the present invention to overcome, or substantially ameliorate, one or more of the disadvantages of the prior art, or to provide a useful alternative.

In one aspect of the present invention there is provided a lockset installation kit including: a door jig configured for attachment to a distal end of a door; and a first template disposed on the door jig such that, in use, the first template is positionable in a predefined geometric relationship relative to the end of the door; wherein the first template is shaped so as to guide a cutting tool in the morticing of a latch plate recess into the end of the door.

Preferably the first template defines a hole shaped so as to correspond to the desired shape of the latch plate recess.

Preferably the first template is removably engagable with the door jig.

In one embodiment the first template is rotatably mounted to the door jig so as, in use, to swivel into an operative position for morticing of the latch plate recess and so as to swivel into a clearance position away from the end of the door.

In one embodiment the door jig includes a self-centring clamp configured to clamp the door jig to the end of the door. In this embodiment the self-centring clamp includes a shaft having a bi-directional screw thread formed thereon, a first jaw being threadedly engaged with a first threaded direction of the bi-directional screw thread and a second jaw being threadedly engaged with a second threaded direction of the bi-directional screw thread.

Preferably the lockset installation kit further includes a first guide hole moveably disposed on the door jig and being positionable in a predefined geometric relationship relative to the end of the door, the first guide hole being configured so as, in use, to guide a cutting tool in the creation of a latch bolt hole and being moveable between an operative position for creation of the latch bolt hole and an inoperative position away from the end of the door. More preferably, the first guide hole is disposed on an arm that is rotatably mounted to the door jig so as, in use, to swivel between the operative position and the inoperative position.

Preferably the predefined geometric relationship of the first template and/or the predefined geometric relationship of the first guide hole is centred relative to the end of the door.

One embodiment of the lockset installation kit further includes a second guide hole disposed on the door jig and being positionable in a predefined geometric relationship relative to the end of the door, the second guide hole being configured so as to, in use, guide a cutting tool in the creation of a door handle hole. In this embodiment the second guide hole is preferably disposed on an arm that is moveably mounted to the door jig so as, in use, to move the second guide hole between an extended position and a retracted position.

An embodiment of the lockset installation kit further includes a depth finder disposed on the door jig, the depth finder being configured for use as a reference for setting a depth of the cutting tool that is to be used for the morticing of the latch plate recess.

An embodiment of the lockset installation kit further includes a frame jig configured for attachment to a door frame, wherein a second template is disposed on the frame jig such that, in use, the second template is positionable in a predefined geometric relationship relative to the door frame and wherein the second template is shaped so as to guide a cutting tool in the morticing of a strike plate recess. Preferably the second template defines a hole shaped so as to correspond to the desired shape of the strike plate recess.

In an embodiment the second template is removably engagable with the frame jig. More specifically, in this embodiment the second template is rotatably mounted to the frame jig so as, in use, to swivel into an operative position for morticing of the strike plate recess and so as to swivel into a clearance position away from the door frame.

Preferably a third guide hole is moveably disposed on the frame jig such that it is positionable in a predefined geometric relationship relative to the door frame. The third guide hole is configured so as to, in use, guide a cutting tool in the creation of a strike hole and it is moveable between an operative position for creation of the strike hole and an inoperative position away from the door frame.

In an embodiment the third guide hole is disposed on an eccentric insert that is received within an aperture disposed in an arm that is rotatably attached to the frame jig.

Preferably at least one clamp is disposed on the frame jig, the at least one clamp being operable, in use, so as to clamp the frame jig to the door frame. Additionally, or alternatively, a fixing formation may be disposed on the frame jig for fastening the frame jig to the door frame.

In an embodiment the door jig is mechanically couplable to the frame jig so as, in use, to assist with the alignment of the first template with the second template and the alignment of the first guide hole with the third guide hole. Preferably the mechanical coupling is provided by an articulated linkage member having an end configured for attachment to the door jig and an opposite end configured for attachment to the frame jig. In an embodiment the articulated linkage member includes a first elongate planar member rotatably attached to a side of an intermediate member so as to define a first axis of rotation and a second elongate planar member rotatably attached to an opposite side of the intermediate member so as to define a second axis of rotation and the first and second axes of rotation are parallel to each other.

The features and advantages of the present invention will become further apparent from the following detailed description of preferred embodiments, provided by way of example only, together with the accompanying drawings.

### BRIEF DESCRIPTION OF THE ACCOMPANYING DRAWINGS

FIG. 1 is a bottom view of a door jig according to an embodiment of the invention;

FIG. 2 is a rear view of the door jig;

FIG. 3 is a plan view of the door jig;

FIG. 4 is an upper-frontal-right hand isometric view of the door jig with the first template removed;

FIG. 5 is an upper-frontal-left hand isometric view of the door jig with the first template removed;

FIG. 6 is an upper-rear-right hand isometric view of the door jig;

FIG. 7 is an upper-rear-left hand isometric view of the door jig;

FIG. 8 is an upper-frontal-right hand isometric view of the door jig with the first template installed and in the operative position;

FIG. 9 is a left side view of the door jig;

FIG. 10 is a right side view of the door jig;

FIG. 11 is a front view of the door jig with the first template in the operative position;

FIG. 12 is a rear view of the door jig with the first guide hole in the operative position;

FIG. 13 is a front view of the door jig with the first guide hole in the operative position;

FIG. 14 is a frontal-upper-right side isometric view of the door jig with the first guide hole in the operative position;

FIG. 15 is left side detail view showing the second guide hole of the door jig in the extended position;

FIG. 16 is a left side detail view showing the second guide hole of the door jig in the retracted position;

FIGS. 17 to 20 are detail views of the depth finder of the door jig;

FIGS. 21 and 22 are isometric views of the depth finder;

FIG. 23 is a frontal-left isometric view of the door jig as attached to a door end with the first template in the clearance position and the first guide hole in the inoperative position;

FIG. 24 is a frontal-left isometric view of the door jig as attached to a door end with the first template in the clearance position and the first guide hole in the operative position;

FIG. 25 is a frontal-left side view of a door end that has been prepared for a lockset installation using the door jig;

FIG. 26 is a similar view to that of FIG. 19 except the hidden internal edges of the latch bolt hole, the latch plate recess and the door handle hole are shown;

FIG. 27 is a left side view of a frame jig according to an embodiment of the invention;

FIG. 28 is a right side view of the frame jig;

FIG. 29 is an upper-rear-left side isometric view of the frame jig;

FIG. 30 is a front view of the frame jig;

FIG. 31 is a rear view of the frame jig;

FIG. 32 is a right side view of the frame jig;

FIG. 33 is a frontal-upper-left side isometric view of the frame jig;

FIG. 34 is a frontal-upper-right side isometric view of the frame jig;

FIG. 35 is a rearward-upper-left side isometric view of the frame jig;

FIG. 36 is a rearward-upper-right side isometric view of the frame jig;

FIG. 37 is a plan view of the frame jig;

FIG. 38 is a front view of the frame jig;

FIG. 39 is a left side detail view of one of the clamps on the frame jig;

FIG. 40 is a isometric view of the clamp;

FIG. 41 is a detail view showing the eccentric insert forming the third guide hole, with the hole in the retracted position;

FIG. 42 is a detail view showing the eccentric insert forming the third guide hole, with the hole in the extended position;

FIG. 43 is an isometric view of a door frame that has been prepared for a lockset installation using the frame jig;

FIG. 44 is an isometric view of an articulated linkage member according to an embodiment of the invention;

FIG. 45 is an isometric view similar to that of FIG. 37, but with hidden detail being shown;

FIG. 46 is a side view of the articulated linkage member;

FIG. 47 is an isometric view showing the articulated linkage member mechanically coupling the door jig as attached to a door end and the frame jig as attached to the door frame; and

FIG. 48 is an isometric view showing the frame jig as attached to the door frame.

### DETAILED DESCRIPTION OF PREFERRED EMBODIMENTS OF THE INVENTION

As shown, for example in FIGS. 1 to 14, the lockset installation kit includes a door jig 1 configured for attachment to a distal end 2 of a door 3. The door jig 1 clamps to the distal end 2 by means of a self-centring clamp 4 having a pair of jaws 5 and 6 that are threadedly engaged with a shaft 7 having a bi-directional screw thread formed thereon. That is, one end of the shaft 7 has a left hand thread formed on it and the other end of the shaft 7 has a right hand thread formed on it. The first jaw 5 is threadedly engaged with one of the threaded directions of the bi-directional screw thread and the second jaw 6 is threadedly engaged with the other threaded direction of the bi-directional screw thread. The middle of the shaft 7 has a circular stop that is housed within projection 8 of the door jig 1. However, the shaft 7 is not threadedly engaged with the projection 8. Hence, rotation of the shaft 7, by means of the user rotating the handle 12, does not cause any linear movement of the shaft 7 relative to the projection 8. Rather, rotation of the shaft causes each of the jaws 5 and 6 to be equally displaced either inwardly or outwardly depending upon the direction of rotation. Hence, whilst being displaced, the jaws 5 and 6 remain equidistant from the centre of the projection 8.

Preferably the internal faces of the first and second jaws 5 and 6 have padding or other soft material applied to them to avoid the clamping action from causing damage to the door end 2.

A first template 9 is disposed on the door jig 1 such that, in use, the first template 9 is positionable in a predefined geometric relationship relative to the door end 2. In the preferred embodiment, this predefined geometric relationship is centered relative to the door end 2. The first template 9 is rotatably mounted to the door jig 1 so as, in use, to swivel into an operative position (as shown for example in FIG. 2) in which the first template abuts the door end 2 in preparation for morticing of the latch plate recess 16. The first template 9 also swivels into a clearance position (as shown for example in FIGS. 14 and 23) away from the door end 2. This provides clearance for the first guide hole (to be discussed in greater detail below) to be moved into an operative position against the door end 2.

FIG. 47 shows the door jig 1 as clamped to the door end 2 with the first template 9 in the operative position. Hence, when the first template 9 is in the operative position, its centre is aligned with the centre of the self-centring clamp 4. This means that clamping the door jig 1 onto the door end 2 automatically centres the first template 9 relative to the door end 2.

The first template 9 is in the form of an insert that defines a hole 10 shaped so as to correspond to the desired shape of the latch plate recess and to thereby guide a cutting tool in the morticing of a latch plate recess 16 into the door end 2. Typically, the cutting tool would be a power tool such as a router. In use, the user threads the cutting bit of the cutting tool through the hole in the first template 9 such that the cutting tool acts against the door end 2. The edges of the hole 10 constrain the cutting bit to ensure that only the desired material is morticed from the door end 2.

The insert that forms the first template 9 is removably engagable with the door jig 1. More specifically, the door jig 1 includes a rectangular frame 11 (as shown for example in FIGS. 4 and 5 without the insert) that is rotatably attached to the door jig 1. The kit includes a plurality of different inserts, each having holes 10 that are shaped to correspond to a specific latch plate shape. Any of these inserts may be selected and clicked into the frame 11, as desired. In this way, the kit can accommodate the various commercially available standard latch plate shapes.

A detent, in the form of a resiliently biased ball bearing that seats into a recess, is used to ensure that the frame 11 clicks into place when the first template 9 is in the operative position. This provides the user with a definite tactile indication that the first template 9 is correctly positioned and helps ensure that the first template does not inadvertently stray from the operative position.

As best shown in FIGS. 15 to 22, a depth finder 20 is disposed on the door jig 1 to assist the user to set the depth of the cutting tool that is to be used for the morticing of the latch plate recess 16. The depth finder 20 has a threaded shaft 21 having a knurled head 22 fixedly attached at the distal end and a pair of circular projections 23 and 24 at the proximal end. The threaded portion of the shaft is threadedly engaged with the portion of the door jig 1 from which it protrudes. The circular projections 23 and 24 are received in slots 25 and 26 that are provided in member 27. Member 27 is connected to planar member 28, which projects from the edge of the door jig 1. Hence, screwing of the knurled head 22 rotates the threaded shaft 21 and the thread causes the shaft to move back or forth depending upon the direction of rotation. This shaft movement causes members 27 and 28 to be displaced back and forth because the movement is transmitted to members 27 and 28 via the circular projections 23 and 24.

To use the depth finder 20, the user places the uninstalled latch plate between the planar member 28 and the surface 29 of the door jig 1. The user then screws the knurled head so as to displace the planar member 28 toward the surface 29 until the latch plate is lightly clamped between the planar member 28 and the surface 29. The user then removes the latch plate without disturbing the position of the planar member 28. The user then ensures that the frame 11 is in the operative position and then places the cutting tool, such as a router, onto the frame. The required cutting depth is then given by the distance between the external side of frame 11 and the planar member 28 (more specifically, the surface of the planar member 28 that is closer to the frame 11 as shown for example in FIG. 9). The user can now set the cutting tool depth for the morticing of the latch plate recess 16 by referencing off this distance.

Once the latch plate recess 16 has been morticed by the cutting tool, the resultant corners of the recess may be rounded. If it is necessary to square-off these corners, a corner chisel may be utilised in the known manner.

A first guide hole 13 is moveably disposed on the door jig 1. More specifically, the first guide hole 13 is disposed on an arm 14 that is rotatably mounted to the door jig 1 so as, in use, to swivel between the operative position (as shown for example in FIGS. 12 to 14 and 24) and the inoperative position (as shown for example in FIGS. 2 to 8 and 23).

When in the operative position the first guide hole 13 is positioned in a predefined geometric relationship relative to the door end 2. More specifically, the length of the arm 14 and its mounting position on the door jig 1 are selected to ensure that the first guide hole 13 is centred on the door end 2 when in the operative position and when the door jig 1 is clamped to the door end 2 by the self-centring clamp 4.

The internal diameter of the first guide hole 13 corresponds to the desired diameter of the latch bolt hole 15. Hence, a cutting tool, such as a drill bit or a boring tool of the desired diameter, may be threaded through the first guide hole 13 whilst it is in the operative position and this will guide the creation of the latch bolt hole. Provided that the door jig 1 remained clamped to the door end 2 whilst both the latch plate recess 16 was morticed and whilst the latch bolt hole 15 was being drilled, the use of the door jig 1 ensures that the latch bolt hole 15 is correctly located within the latch plate recess 16.

The door jig 1 also includes a second guide hole 17 that is disposed so as to be positionable in a predefined geometric relationship relative to the door end 2. The second guide hole is configured so as to, in use, guide a cutting tool, such as a circular saw, in the creation of a door handle hole 18. The predefined geometric relationship corresponds to a standard distance by which the door handle is typically set back from the door end 2. The preferred embodiment accommodates two such standard distances: 60 mm and 70 mm. For this reason, the second guide hole 18 is disposed on an arm 19 that is moveably mounted to the door jig 2. As shown for example in FIG. 15, the arm 19 is in the extended position and hence the second guide hole 18 is set back from the door end 2 by 70 mm. As shown for example in FIG. 16, the arm 19 is in the retracted position, which means that the second guide hole 18 is set back from the door end 2 by 60 mm. The user can simply displace the arm 19 between the two positions as required. Once again, ball bearing detents are used to define the two positions and to retain the arm in the 60 mm or 70 mm set back position, as required for the particular lockset that is being installed.

FIGS. 25 and 26 depict the latch plate recess 16, the latch bolt hole 15 and the door handle hole 18 as formed in the door end 2.

As shown for example in FIGS. 27 to 39, the embodiment of the lockset installation kit also includes a frame jig 29 configured for attachment to a door frame 30. The preferred embodiment provides two ways in which the frame jig 29 may be attached to the door frame 30. One option is to use one or more clamps and the preferred embodiment has a pair of clamps 31 and 32 that are slidably disposed on respective arms 33 and 34. When the knobs 35 and 36 of the clamps 31 and 32 are loosened, the clamps are free to slide along the slots 37 and 38 that extend along the arms 37 and 38. This allows the user to position the frame jig 29 against the door frame 30 and to slide each of the clamps so that they abut a projection, such as skirting board 48, in the door frame 30. The user then tightens the knobs 35 and 36, which fixes the positions on the clamps 31 and 32 on the arms 33 and 34. The user then turns handles 39 and 40 on the respective clamps 31 and 32, which tightens the clamps against the skirting board 48 and clamps the frame jig 29 in place. Advantageously, the use of these clamps typically avoids damaging the door frame 30.

As an alternative to the use of the clamps 31 and 32, the preferred embodiment of the frame jig also provides a pair of fixing formations in the form of holes through which fasteners such as screws 41 and 42, or the like, may extend. These screws 41 and 42 screw into the door frame 30 and thereby fasten the frame jig 29 to the door frame 30. It will be appreciated that once the door jig is removed, the screws 41 and 42 will leave holes in the door frame 30, which will require patching.

A second template 43 is disposed on the frame jig 29. More particularly, the second template is an insert 44 that defines a hole 45 shaped so as to correspond to the desired shape of the strike plate recess 46. The insert clicks into a frame 47 that is rotatably mounted to the frame jig 29. The kit includes a number of inserts each having holes shaped to suit various commercially available strike plates. The removable mounting of the insert 44 into the frame 47 allows the user to select the insert having the appropriately shaped hole for the strike plate that is being installed and to click that insert into the frame 47 so that it is ready to assist with the morticing of the strike plate recess 46.

The frame 47 is rotatably mounted to the frame jig 29, which allows it to be swivelled between an operative position (as shown for example in FIGS. 31 and 33 to 38) for morticing of the strike plate recess 46 and a clearance position (as shown for example in FIGS. 29, 30 and 48) away from the door frame 30.

The frame jig 29 is attached to the door frame such that surfaces 63 and 64 abut the side of the skirting board 48 that is adjacent to the area in which the strike plate is to be installed. The dimensions of the door jig 29 ensure that when correctly mounted in this manner, and when the frame 47 is in the operative position, the second template 43 is positioned in a predefined geometric relationship relative to the door frame. That is, it ensures that the hole 45 in the insert is positioned immediately in front of the area in which the strike plate recess 46 is to be morticed. The user then inserts a cutting tool, such as a cutting bit of a router, through the hole 45 and uses the shape of the hole 45 as a guide in the morticing of the strike plate recess 46. When the cutting bit impacts upon one of the edges of the hole 45, it stops the cutting tool from straying into an unwanted section of the door frame 30. Once again, it may be desirable to utilise a corner chisel to square-off the corners of the strike plate recess 46.

A third guide hole 49 is moveably disposed on the frame jig 29. More particularly, the third guide hole 49 is disposed on an eccentric insert 50 that is received within an aperture 51 disposed in an arm 52 that is rotatably attached to the frame jig 29. The eccentric insert allows the kit to accommodate two standard door frame sizes: 35 mm and 40 mm. To accommodate the smaller frame size, the eccentric insert 50 is positioned in the aperture 51 as illustrated in FIG. 41 (i.e. the eccentric insert 50 is rotated such that the third guide hole 49 is positioned as close as possible to the base of the arm 52). To accommodate the larger frame size, the eccentric insert 50 is positioned in the aperture 51 as illustrated in FIG. 42 (i.e. the eccentric insert 50 is rotated through 180° such that the third guide hole 49 is positioned as far as possible from the base of the arm 52).

The arm 52 may be rotated relative to the frame jig 29 so as to move the third guide hole 49 between an operative position (as shown for example in FIGS. 29, 30 and 48) for creation of the strike hole 65 and an inoperative position (as shown for example in FIGS. 32 to 38) where the third guide hole 49, and the arm 52, is positioned away from the door frame 30.

When the frame jig 29 is properly attached to the frame (as outlined above), and when the third guide hole 49 is in the operative position, and when the eccentric insert 50 is in the correct position for the size of the door frame 29, the third guide hole 49 is positioned in a predefined geometric relationship relative to the door frame 30. That is, the third guide hole 49 is positioned immediately in front of the desired position of the strike hole 65. When in this configuration, the user threads a cutting tool, such as a drill bit or a borer, through the third guide hole 49, which guides the cutting tool in the creation of a strike hole 65. More specifically, the inner diameter of the third guide hole 49 is sized so as to snuggly receive the outer diameter of the cutting tool and thereby direct it to the desired position.

It is important to ensure that the strike plate recess 46 and strike hole 65 in the door frame 30 are accurately aligned with the latch plate recess 16 and the latch bolt hole 15 in the door end 2. To assist with this alignment, the kit provides for the door jig 1 to be mechanically coupled to the frame jig 29 so as, in use, to assist with the alignment of the first template with the second template and hence with the alignment of the first guide hole with the third guide hole. Firstly the user establishes a height at which to attach the door jig 1 onto the door end, which will later define the heights of the latch plate recess 16 and the latch bolt hole 15. The user then mechanically couples the door jig 1 to the frame jig 29 and rotates the door 3 until the frame jig 29 is adjacent the door frame 30. The user then attaches the frame jig 29 to the door frame 30 whilst maintaining the mechanical coupling to the door jig 1. This will ensure that the frame jig 29 is attached at a height that corresponds to the height of the door jig 1. This, in turn, will ensure that the strike plate recess 46 and strike hole 65 are accurately aligned with the latch plate recess 16 and the latch bolt hole 15. Alternatively, the user may firstly attach the frame jig 29 to the door frame 30 at the desired height, and then use the mechanical coupling to ensure that the door jig 1 is attached to the door end 2 at a corresponding height.

The mechanical coupling is provided by an articulated linkage member 53, as illustrated for example in FIGS. 44 to 46. The articulated linkage member 53 includes a first elongate planar member 58 rotatably attached by a first pin 59 to a side of an intermediate member 60 such that the first pin 59 defines a first axis of rotation. A second elongate planar member 61 is rotatably attached at second pin 62 to an opposite side of the intermediate member 60 such that the second pin 62 defines a second axis of rotation. The first and second axes of rotation are parallel to each other, which, in use, allows the articulated linkage member 53 to articulate without changing its height. As best shown in FIG. 47, this allows the articulated linkage member 53 to connect the door jig 1 and the frame jig 29 despite the difference in orientation of the partially open door 2 relative to the fixed door frame 30.

The articulated linkage member 53 has an end 54 configured for attachment to the door jig 1 and an opposite end 55 configured for attachment to the frame jig 29. The end 54 is shaped so as to be received into boss 56 on the door jig 1. The end 55 is shaped so as to be received into boss 57 on the frame jig 29. The cross sectional shapes of the ends 54 and 55 are rectangular and the internal shape of the bosses 56 and 57 correspond to this rectangular shape. Hence, this arrangement ensures that the mechanical coupling provided by the articulated linkage member 53 aligns the door jig 1 and the frame jig 29 with an accuracy that is sufficient for the installation purposes. Once door jig 1 and the frame jig 29 are each securely and correctly attached, they can be de-coupled, if so desired.

FIG. 43 illustrates the strike plate recess 46 and the strike hole 65 as formed in the door frame 30 using the embodiment of the kit. Once the door end 2 and the door frame 30 have been prepared in the manner outlined above, the user proceeds to install the lockset into the various holes and recesses in the usual manner.

Some specific dimensions have been mentioned above with regard to the sizing of some components of the kit to allow the kit to accommodate various standard sizes of latch plates, strike plates, door frames, etc. It will be appreciated by those skilled in the art that variations to these dimensions may be readily made to some of the components to alter the kit to allow it to accommodate other sizes of latch plates, strike plates, door frames, etc.

It will be appreciated by those skilled in the art that the morticing of the latch plate recess 16 and the strike plate recess 46 is typically the most difficult and time consuming part of installing a lockset using the prior art methods. The embodiment of the kit advantageously assists with morticing these formations with the desired size, depth and alignment.

It is also advantageous that the embodiment of the kit can provide assistance with all of the major steps of the installation of a lockset (i.e. the boring out of the door handle hole 18, the boring out of the latch bolt hole 15, the morticing of the latch bolt plate recess 16, the boring out of the strike bolt hole 65 and the morticing of the strike plate recess 46).

While a number of preferred embodiments have been described, it will be appreciated by persons skilled in the art that numerous variations and/or modifications may be made to the invention without departing from the spirit or scope of the invention as broadly described. The present embodiments are, therefore, to be considered in all respects as illustrative and not restrictive.

1. A lockset installation kit including:
a door jig configured for attachment to a distal end of a door; and
a first template disposed on the door jig such that, in use, the first template is positionable in a predefined geometric relationship relative to the end of the door;
wherein the first template is shaped so as to guide a cutting tool in the morticing of a latch plate recess into the end of the door.

2. The lockset installation kit according to claim 1 wherein the first template defines a hole shaped so as to correspond to the desired shape of the latch plate recess.

3. The lockset installation kit according to claim 1 wherein the first template is removably engagable with the door jig.

4. The lockset installation kit according to claim 1 wherein the first template is rotatably mounted to the door jig so as, in use, to swivel into an operative position for morticing of the latch plate recess and so as to swivel into a clearance position away from the end of the door.

5. The lockset installation kit according to claim 1 wherein the door jig includes a self-centring clamp configured to clamp the door jig to the end of the door and wherein the self-centring clamp includes a shaft having a bi-directional screw thread formed thereon, a first jaw being threadedly engaged with a first threaded direction of the bi-directional screw thread and a second jaw being threadedly engaged with a second threaded direction of the bi-directional screw thread.

6. (canceled)

7. The lockset installation kit according to claim 1 further including a first guide hole moveably disposed on the door jig and being positionable in a predefined geometric relationship relative to the end of the door, the first guide hole being configured so as, in use, to guide a cutting tool in the creation of a latch bolt hole and being moveable between an operative position for creation of the latch bolt hole and an inoperative position away from the end of the door and wherein the first guide hole is disposed on an arm that is rotatably mounted to the door jig so as, in use, to swivel between the operative position and the inoperative position.

8. (canceled)

9. The lockset installation kit according to claim 1 wherein the predefined geometric relationship of the first template and/or the predefined geometric relationship of the first guide hole is centred relative to the end of the door.

10. The lockset installation kit according to claim 1 further including a second guide hole disposed on the door jig and being positionable in a predefined geometric relationship relative to the end of the door, the second guide hole being configured so as to, in use, guide a cutting tool in the creation of a door handle hole and wherein the second guide hole is disposed on an arm that is moveably mounted to the door jig so as, in use, to move the second guide hole between an extended position and a retracted position.

11. (canceled)

12. The lockset installation kit according to claim 1 further including a depth finder disposed on the door jig, the depth finder being configured for use as a reference for setting a depth of the cutting tool that is to be used for the morticing of the latch plate recess.

13. The lockset installation kit according to claim 1 further including a frame jig configured for attachment to a door frame, wherein a second template is disposed on the frame jig such that, in use, the second template is positionable in a predefined geometric relationship relative to the door frame and wherein the second template is shaped so as to guide a cutting tool in the morticing of a strike plate recess.

14. The lockset installation kit according to claim 10 wherein the second template defines a hole shaped so as to correspond to the desired shape of the strike plate recess.

15. The lockset installation kit according to claim 10 wherein the second template is removably engagable with the frame jig.

16. The lockset installation kit according to claim 10 wherein the second template is rotatably mounted to the frame jig so as, in use, to swivel into an operative position for morticing of the strike plate recess and so as to swivel into a clearance position away from the door frame.

17. The lockset installation kit according to claim 10 further including a third guide hole moveably disposed on the frame jig and being positionable in a predefined geometric relationship relative to the door frame, the third guide hole being configured so as to, in use, guide a cutting tool in the creation of a strike hole and being moveable between an operative position for creation of the strike hole and an inoperative position away from the door frame.

18. The lockset installation kit according to claim 14 wherein the third guide hole is disposed on an eccentric insert that is received within an aperture disposed in an arm that is rotatably attached to the frame jig.

19. The lockset installation kit according to claim 10 further including at least one clamp disposed on the frame jig, the at least one clamp being operable, in use, so as to clamp the frame jig to the door frame.

20. The lockset installation kit according to claim 10 further including a fixing formation disposed on the frame jig for fastening the frame jig to the door frame.

21. The lockset installation kit according to claim 10 wherein the door jig is mechanically couplable to the frame jig so as, in use, to assist with the alignment of the first template with the second template and the alignment of the first guide hole with the third guide hole.

22. The lockset installation kit according to claim 18 wherein the mechanical coupling is provided by an articulated linkage member having an end configured for attachment to the door jig and an opposite end configured for attachment to the frame jig.

23. The lockset installation kit according to claim 19 wherein the articulated linkage member includes a first elongate planar member rotatably attached to a side of an intermediate member so as to define a first axis of rotation and a second elongate planar member rotatably attached to an opposite side of the intermediate member so as to define a second axis of rotation and wherein the first and second axes of rotation are parallel to each other.
